(19) United States
(12) Patent Application Publication
(10) Pub. No.: US 2007/0087661 A1
(43) Pub. Date: Apr. 19, 2007

(54) Dicing apparatus and dicing method

(75) Inventors: Masanobu KOYATA, Mitaka-shi, Tokyo (JP); Hiroyuki YASUTOMI, Mitaka-shi, Tokyo (JP); Tetsurou NISHIDA, Mitaka-shi, Tokyo (JP); Hirofumi SHIMODA, Mitaka-shi, Tokyo (JP)

Correspondence Address: ROBERTS, MLOTKOWSKI & HOBBES, P. O. BOX 10064, MCLEAN, VA, 22102-8064, US

(73) Assignee: TOKYO SEIMITSU CO., LTD., Tokyo (JP)

(21) Appl. No.: 11/548,887

(22) Filed: Oct. 12, 2006

(30) Foreign Application Priority Data
Oct. 14, 2005 (JP) 2005-300430

(51) Int. Cl. B24B 51/00; B28D 1/04; B24B 7/30

(52) U.S. Cl. 451/5; 451/41; 125/13.01

(57) ABSTRACT

The present invention provides a dicing apparatus which machines with rotary blades a groove in, or cuts, a work mounted on a work table, wherein: a dicing tape to whose upper face the work is stuck can be stuck to or detached from the work table; a contact type displacement meter for measuring the upper face of the dicing tape fitted to the work table is provided; and a cutting depth controlling device which controls the depth of cutting by the rotary blades into the work on the basis of the measured position of the upper face of the dicing tape in the vertical direction is further provided.

### BACKGROUND OF THE INVENTION

1. Field of the Invention

The present invention relates to a dicing apparatus and a dicing method, and more particularly to a dicing apparatus and a dicing method for use in cutting grooves in or cutting works, such as semiconductors and materials for electronic parts.

2. Description of the Related Art

A dicing apparatus which is used in cutting grooves in or cutting works, such as semiconductors and materials for electronic parts, machines the work with thin grind stones known as blades turning at high speed while applying grinding water to the work. In the usual mechanism of such a dicing apparatus, spindle holding the blades are subjected to index feeding in the direction of the Y axis and cut feeding in the direction of the Z axis, and a work table on which the work is mounted is subjected to grind feeding in the direction of the X axis.

The work is integrally stuck to a rigid frame via a dicing tape having an adhesive agent on its surface. In this way, the work is mounted on a work table in the state of being stuck to the frame. When a work is to be ground by this dicing apparatus, data regarding the work are inputted in advance to the controller of the dicing apparatus itself and stored in a memory.

Data regarding a work would include the product type number, material, external dimensions, thickness, chip size, data on alignment and the dicing tape thickness. For the work thickness, the standard value prescribed for each product type of the work, and for the dicing tape thickness the tape manufacturer's nominal value is entered. When a groove is to be cut in this work, it is accomplished by setting the remaining thickness of the work and leaving that thickness uncut.

In order to do the machining with the set thickness left uncut, a groove is cut from an initial position, which means the positions of the rotary blades in the vertical direction where the rotary blades and the upper face of the work table come into contact with each other, to a position in which the rotary blades are lifted as much as the set uncut thickness. For instance, when the work is to be completely cut, the uncut thickness is set to 80 to 90 μm so that a depth of 10 to 20 μm is cut into the dicing tape where the thickness of the dicing tape is 100 μm.

However, by this conventional method of setting the uncut thickness, in bevel cutting for instance by which a V-groove is to be formed with rotary blades each having a V-shaped tip into a work mounted on a work table with a dicing tape in-between, there is a problem that any fluctuation in the thickness of the work W would change the depth and width of the V-groove.

With a view to solving this problem, the present applicant proposed dicing apparatuses whose rotary blades are controlled in cutting depth on the basis of the position of the upper face of the work in the vertical direction measured with a laser displacement meter, which is a non-contact type position sensor (see Japanese Patent Application Laid-Open No. 2003-151923 and Japanese Patent Application Laid-Open No. 2003-168655). It has been confirmed that this method enables the groove depth to be stabilized and, where a V-groove is to be cut for instance, a stable groove width can be secured.

### SUMMARY OF THE INVENTION

However, these earlier proposed dicing apparatuses still involve a problem of being unable to satisfactorily accomplish dicing to half-cut or semi-fully cut the work. Thus, when the work is to be half-cut or semi-fully cut, the uncut thickness of the work should be accurately controlled, but by the conventional method of measuring the position of the upper face of the work in the vertical direction, fluctuations in the thickness of the work (e.g. ±10 μm) prevent the uncut thickness from being controlled accurately.

As an alternative to this conventional method of measuring the position of the upper face of the work in the vertical direction, it is conceivable to measure the position of the upper face of the dicing tape in the vertical direction and to control the cut depths of the rotary blades in the dicing process with reference to this position.

However, since the dicing tape is either transparent or translucent, measurements with a laser displacement meter are susceptible to errors (because it is difficult for a laser displacement meter to read the surface position of the dicing tape), and it is therefore difficult to half-cut or semi-fully cut the work.

Further in a state in which grinding water intervenes between the dicing tape and the work table, it is confirmed that the measurement is subject to 20 to 50 μm errors due to the reflection of the laser beam by the rear face of the dicing tape.

Or, though it is possible to put a reading mark (scratch or the like on the surface of the dicing tape), focus an optical microscope on it and measure the thickness of the dicing tape from the extent of the movement of the objective lens, this requires a high magnitude to ensure accuracy, which means inadaptability to industrial production.

An object of the present invention, attempted in view of the circumstances noted above, is to provide a dicing apparatus and a dicing method having a detector capable of accurately detecting the upper face of the dicing tape in the vertical direction, capable of ensuring the uncut thickness of the work all the time and permitting appropriate half-cutting or semi-full cutting.

In order to achieve the object stated above, the invention provides a dicing apparatus which machines with rotary blades a groove in, or cuts, a work mounted on a work table, wherein a dicing tape to whose upper face the work is stuck can be stuck to or detached from the work table; a contact type displacement meter for measuring the upper face of the dicing tape fitted to the work table is provided; and a cutting depth controlling device which controls the depth of cutting by the rotary blades into the work on the basis of the measured position of the upper face of the dicing tape in the vertical direction is further provided.

For the same purpose, the invention provides a method of dicing to half-cut or semi-fully cut a work by subjecting a work, which is mounted on a work table with a dicing tape in-between and whose lower face is adhesively supported by a dicing tape, to groove cutting or cutting-off with rotary blades, whereby the depth of cutting by the rotary blades into the work are controlled on the basis of a first measurement by which the upper face of the work table is measured with a contact type displacement meter; a second measurement by which the upper face of the dicing tape, fitted in the position of the first measurement of the work table, is measured with the contact type displacement meter; and the result of calculation of the thickness of the dicing tape from the results of the first and second measurements.

According to the invention, there is provided a contact type displacement meter for measuring the upper face of a dicing tape to whose upper face a work is stuck can be stuck to or detached from a work table, and the depth of cutting by rotary blades into the work is controlled on the basis of the measured position of the upper face of the dicing tape in the vertical direction. Therefore, the uncut thickness of the work is secured all the time to make possible appropriate half cutting or semi-full cutting.

Thus, in place of the conventionally used method of measuring the position of the upper face of the work in the vertical direction with a laser displacement meter, which is a non-contact type position sensor, a method of measuring the position of the upper face of the of the dicing tape in the vertical direction with a contact type (probe type) displacement meter is adopted. This enables the upper face of the dicing tape to be accurately measured.

Further according to the invention, since a contact type displacement meter is used and measurement is done with a prescribed stylus pressure, the thickness of the work table can be accurately measurement even in a state in which the dicing tape is not sufficiently stuck to and is off the work table or there are bubbles between the dicing tape and the work table.

The advantages of half-cutting or semi-fully cutting a work include significantly less wear (abrasion) of rotary blades than, and accordingly a substantially reduced cost of rotary blades compared with, conventional full cutting (cutting to the dicing tape by a prescribed depth).

In the configuration according to the invention, the contact type displacement meter is supported by the apparatus body via a cylinder device, and it is preferable for the meter to be able to move away from the vicinities of the work table so as not to interfere with the rotary blades. If the contact type displacement meter can move away so as not to interfere with the rotary blades in this way, it will be favorable both in terms of the convenience of use and in respect of hardware layout.

Further according to the invention, it is preferable for the minimum length readable by the contact type displacement meter to be 1.0 μm or less and the linearity of its measurable range to be ±0.5% or less. A contact type displacement meter precise to this level would be suitable for controlling the uncut thickness of the work. Incidentally, it is even more preferable for the minimum length readable by the contact type displacement meter to be 0.2 μm or less and the linearity of its measurable range to be ±0.1% or less.

It is also preferable according to the invention for the probe pressing force of the contact type displacement meter to be less than 2.0 N. According to the invention it is preferable for the radius of curvature of the probe tip of the contact type displacement meter to be 5 mm or more. A probe pressing force of this level and a relatively flat probe tip would permit accurate measurement of the thickness of the dicing tape. It is even more preferable for the probe pressing force to be 0.5 to 1.6 N. The radius of curvature of 5 mm or more of the probe tip includes a plane (whose radius of curvature is infinite).

Further the configuration according to the invention may have a mapping device which draws the map of the upper face of the dicing tape from the results of measurement of positions in the vertical direction at a plurality of points on the upper face of the dicing tape detected by the contact type displacement meter, and it is preferable for the cutting depth controlling device to control the cutting depth of the rotary blades on the basis of the map so drawn. The presence of such a mapping device enables the thickness distribution in the face of the dicing tape to be identified and the cutting depth of the rotary blades to be controlled correspondingly more reliably.

As described above, the invention ensures the uncut thickness of the work all the time and permits appropriate half-cutting or semi-full cutting.

### BRIEF DESCRIPTION OF THE DRAWINGS

FIG. 1 shows an external perspective view of a dicing apparatus, which is an embodiment of the present invention;

FIG. 2 shows a front view of the main part of the dicing apparatus embodying the invention;

FIG. 3 shows a perspective view of a work stuck to a frame via a dicing tape;

FIGS. 4A and 4B are enlarged views showing states of the main part measured with a contact type displacement meter;

FIG. 5 is a table of measured thicknesses of a dicing tape; and

FIG. 6 is a table of measured uncut thicknesses of a work.

### DETAILED DESCRIPTION OF THE PREFERRED EMBODIMENT

A dicing apparatus and a dicing method which constitute a preferred embodiment of the present invention will be described in detail below with reference to the accompanying drawings, in which the same reference numbers or signs are assigned to respectively the same members.

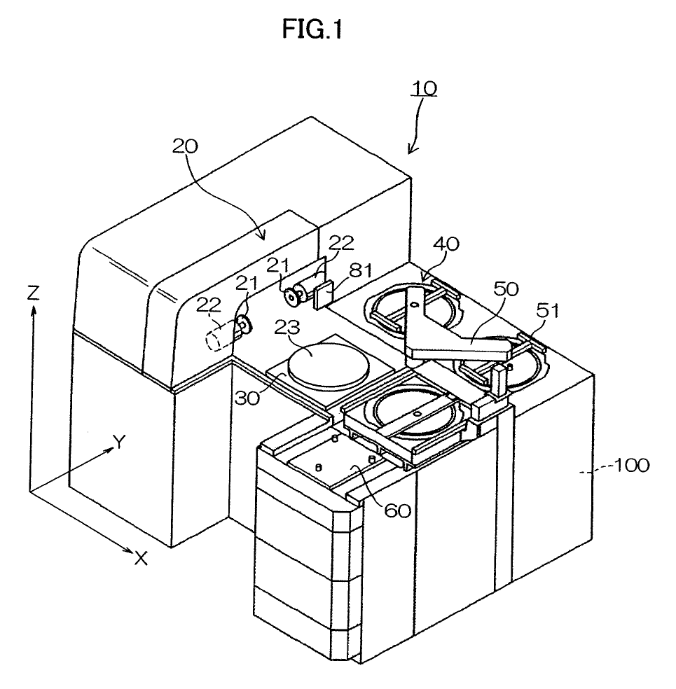

First, the configuration of the dicing apparatus will be described. FIG. 1 shows an external perspective view of the dicing apparatus according to the invention.

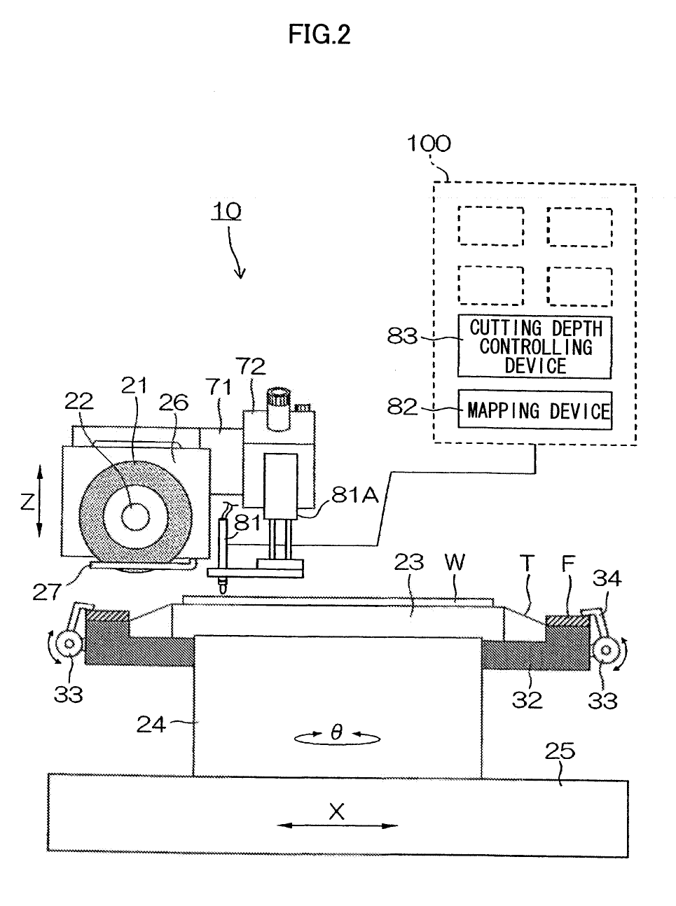

A dicing apparatus 10 comprises a load port 60 for exchanging with an external device a cassette (not shown) in which a plurality of works are accommodated, a conveying device 50 having a sucking part 51 and carrying works to various parts of the apparatus, a contact type displacement meter 81 for detecting the upper face of a dicing tape T (see FIG. 2 and elsewhere) or of the work, a machining part 20, a spinner 40 which washes and dries machined works and a controller 100 which controls the operations of other constituent parts of the apparatus.

The machining part 20 is provided with two oppositely arranged air bearing type spindles 22 and 22 each having a built-in high frequency motor, to which rotary blades 21 are fitted. The rotary blades 21 are turned at a high speed of 30,000 rpm to 60,000 rpm, and are subjected to index feeding and cut feeding respectively in the Y direction and the Z direction in the drawing, independent of each other. A work table 23 which is mounted with a work by suction is subjected to grind feeding in the X axis in the drawing by the movement of an X table 30.

FIG. 2 shows a front view of the main part of the dicing apparatus 10. The dicing apparatus 10 has an X table 25 moved in the X axis in the drawing by a driving device (not shown), the X table 25 is mounted with a θ table 24 turning in the θ direction in the drawing, and the work table 23 is fitted to the θ table 24.

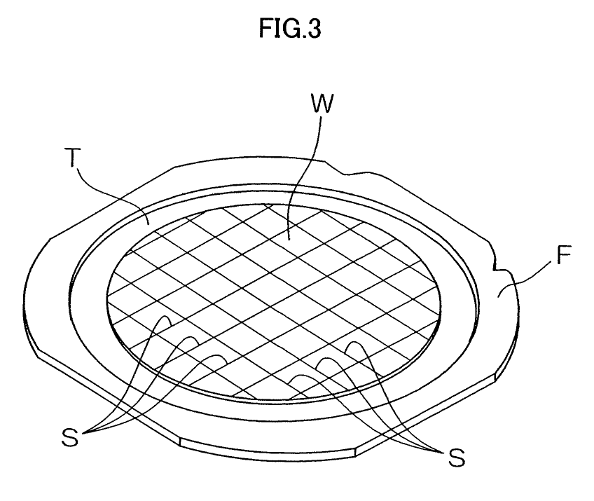

As the perspective view of FIG. 3 illustrates, a work W to be machined is stuck to a frame F via a dicing tape T having an adhesive agent on the surface, and sucked by the work table 23. At the same time, the frame F is mounted on bearers 32 and 32 fitted to the work table 23, and clamped by a damper 34 of a rotary actuator 33 disposed on each of the bearers 32 and 32. Incidentally in FIG. 3, streets S, S . . . , which are the planned machining lines of the work W, are marked in a grid form.

The work W is turned in the θ direction by such a mechanism, and subjected to grind feeding in the X axis. On the other hand, the rotary blades 21 fitted to the spindles 22 are covered by a flange cover 26 whose front and lower faces are open, and the flange cover 26 is provided with cooling nozzles 27 and 27 for supplying cooling water so as to hold the rotary blades 21 between them from front and back. These rotary blades 21 are thin disks, which may be an electrodeposited blade formed by electrodepositing abrasive grains of diamond or CBN over a nickel base or a resin blade bonded with resin.

Further, the spindles 22 are subjected to cut feeding and index feeding respectively in the Z direction and the Y direction (the direction orthogonal to the drawing surface) in FIG. 2 by a driving device (not shown). A microscope 72 is also fitted to the spindles 22 via a holder arm 71, and the contact type displacement meter 81 is fitted to the microscope 72 via a cylinder stage 81A to enable the upper face positions of the work table 23 and of the dicing tape T.

Incidentally, the contact type displacement meter 81 is a common instrument for measuring the length by using a differential transformer or a moiré scale (linear scale), and its structure and principle of measuring will not be described here because they are well known.

In this dicing apparatus 10, a displacement sensor produced by Keyence Corporation (Model No.: AT-001V) is used as the contact type displacement meter 81 (sensor head). The minimum length readable by this sensor head is 0.1 μm, and the linearity of its measurable range is ±0.05%. The measuring force (stylus pressure) is 0.88 N. Incidentally, though the measurable range is only ±0.5 mm, there is no problem in measuring because the vertical positioning of the contact type displacement meter 81 can be set with the cylinder stage 81A.

While the probe (stylus tip) of the contact type displacement meter 81 can be selected out of a number of optional types, it is preferable for the radius of curvature of the probe tip to be 5 mm or more. If the radius of curvature of the tip is too small, the extent of the sinking of the probe tip into the dicing tape T cannot be constant, resulting in deteriorated measuring accuracy.

As the contact type displacement meter 81 is fixed to the spindles 22 via the cylinder stage 81A, the microscope 72 and the holder arm 71 in this way, it is index-fed in the Y direction and index-fed in the Z direction together with the rotary blades 21 and the microscope 72. Further, the contact type displacement meter 81 is supported by the apparatus body (the microscope 72 in this case) via the cylinder stage 81A, and can move away from the vicinities of the work table 23 so as not to interfere with the rotary blades 21.

The controller 100 for controlling the operations of the parts constituting the dicing apparatus is equipped with a mapping device 82 which, receiving data on the displacements of different parts of the upper face of the dicing tape T detected by the contact type displacement meter 81, draws the map of the upper face of the dicing tape T. This map relates the XY coordinates of each part of the upper face of the dicing tape T with the Z coordinate in that position. The controller 100 is also provided with a cutting depth controlling device for controlling the heights of the rotary blades 21 on the basis of the map drawn by the mapping device 82. Incidentally, the mapping device 82 is not indispensable for the present invention.

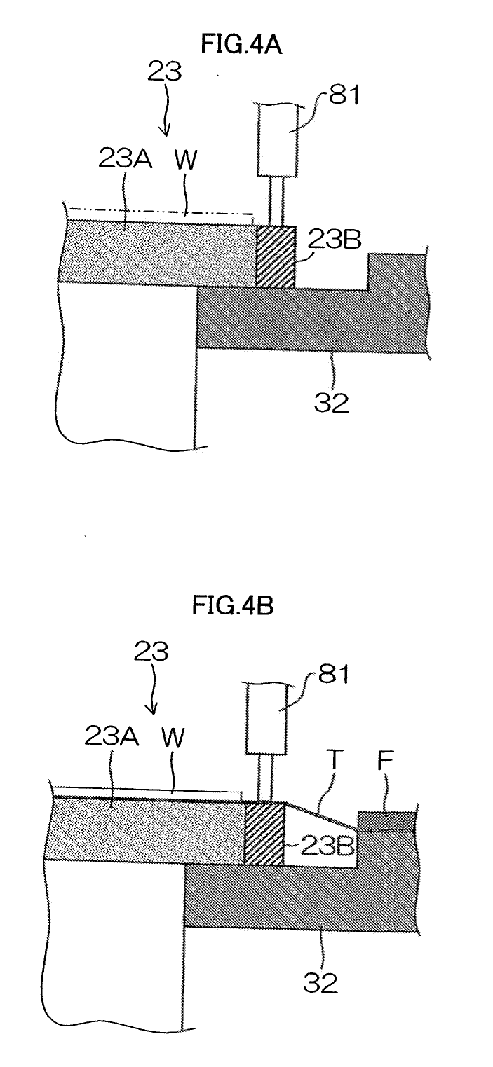

Next, the actions of the dicing apparatus configured in this way will be described. First, the work table 23 moves to underneath the contact type displacement meter 81, and the upper face position (the Z coordinate datum) of the work table 23 is acquired. FIG. 4A is an enlarged view showing a state of the main part measured with the contact type displacement meter 81.

The work table 23 comprises a sucking part 23A which is arranged in the central part and of substantially the same planar size as the work W and a peripheral flange part 23B. This sucking part 23A is formed of porous ceramic, and the flange part 23B, of stainless steel. The upper face of the sucking part 23A and that of the flange part 23B are formed on the same plane.

As shown in FIG. 4A, first the Z coordinate datum of the work table 23 in a state in which the dicing tape T is not yet stuck is acquired as a first measured coordinate. Incidentally, the work W is indicated by an imaginary line.

This measurement is done on a plurality of positions (e.g. at 90 degree intervals in the circumferential direction) on the upper face of the flange part 23B. The first measured coordinate of the pertinent region is thereby acquired.

Next, a cassette in which a plurality of works W, each stuck to the frame F via the dicing tape T, are accommodated is handed over to the load port 60 of the dicing apparatus 10 by an external conveying device.

Then, the works W are drawn out of the cassette one by one by the conveying device 50 of the dicing apparatus 10, and sucked by the work table 23.

Next, the Z coordinate datum of the work table 23 in a state in which the dicing tape T is stuck to it is acquired as a second measured coordinate. FIG. 4B is an enlarged view showing this state of the main part measured with the contact type displacement meter 81. This measurement is accomplished of the same region as the earlier first measured coordinate.

In this way, the Z coordinate data (the first measured coordinate and the second measured coordinate) on each region to be measured (XY coordinates) are acquired to enable the thickness datum of the dicing tape T in each region to be measured to be figured out.

The acquired data are delivered to the mapping device 82 in the controller 100, and a map of the upper face of the dicing tape T is drawn. Incidentally, as the coordinate of the lower end of each rotary blade 21 in the initial position on the Z axis is measured in advance and therefore known, the Z coordinate for cutting to a prescribed extent from the upper face position of the work W can be readily obtained by simple calculation. When the map of the dicing tape T is drawn, the work W is fed to the machining part 20 and its machining is started.

In this process, the work table 23 is moved to underneath the microscope 72, and the patterned part formed on the upper face of the work W is picked up by a CCD camera connected to the microscope 72 to enable its alignment by a known pattern matching technique.

In machining the work W, a cutting depth controlling device 83 in the controller 100 controls the positions of the rotary blades 21 in the Z direction in accordance with the map of the upper face of the dicing tape T drawn by the mapping device 82. In the machining process, one line is worked upon by the grind feeding of the work table 23 in the X direction, the rotary blades 21 are index-fed by one pitch in the Y direction to be positioned on the next street S (see FIGS. 4A and 4B), and this line is also worked on by the grind feeding of the work table 23 in the X direction.

As this operation is repeated, machining of all the streets S of the work W in one direction is completed. When all the lines in one direction have been machined, the work W is turned by 90 degrees by the rotation of the θ table 24, and the streets S orthogonal to the streets S earlier machined are worked upon. Positional control of the rotary blades 21 in the Z direction may be controlled, with respect to each individual line, on a representative value (e.g. the average) of Z coordinates on the line, or machining may be performed under constant control matching positions in the X and the Y directions.

After the evaluation of machined grooves is done, the work W is conveyed by the conveying device 50 to the spinner 40 to undergo spin washing and spin drying. The work W having gone through washing and drying is returned to the cassette by the conveying device 50. The flow of machining a work W by the dicing apparatus according to the present invention is as described above.

According to the invention, as described so far, since the thickness of the dicing tape T is measured by the contact type displacement meter 81 in advance of machining a work W and the rotary blades 21 are controlled according to the end position of the depth of cutting into the work W, the uncut thickness is steady even if the thickness of the work W is uneven, making possible appropriate half cutting or semi-full cutting.

While a dicing apparatus and a dicing method embodying the present invention have been described so far, the invention is not limited to this embodiment but can be implemented in various other modes.

For instance, though the contact type displacement meter 81 is fitted via the cylinder stage 81A to the microscope 72 for alignment use in the foregoing embodiment, this is not the only possibility but a dedicated driving device may be provided to move it.

Although the thickness of the dicing tape T is measured with the contact type displacement meter 81 in the foregoing embodiment, it is also possible to measure the upper surface position of the work W with the contact type displacement meter 81 and to control the depth of cutting into the work W on that basis. This would be very effective for a work which is difficult to measure with a non-contact type displacement meter (because of a low optical reflectance of the surface), such as a ceramic work for instance.

### EXAMPLES

The present invention will be described in more specific terms with reference to examples, but the invention is not limited to these examples.

Dicing of works W was carried out by using the dicing apparatus 10 illustrated in FIG. 1 and FIG. 2. The works W used were silicon wafers measuring 75 mm in external diameter (nominally 3 inch size) (500 μm in thickness). The dicing tape T used was a product of Lintec Corporation (Model No.: D-171). This dicing tape T is 90 μm thick (standard thickness).

The rotary blades 21 measure 55.56 mm in external diameter and turn at 50,000 rpm. The grind feeding speed in the X direction was set to 20 mm/second.

The target uncut thickness in half cutting was 250 μm.

These conditions are common to the example of the invention and the comparative example.

In the example, the aforementioned contact type displacement meter 81 (a product of Keyence Corporation, Model No.: AT-001V) was used. The probe (stylus tip) of this contact type displacement meter 81 is flat-shaped, measuring 0.8 mm in external diameter. Before carrying out this experiment, the depth of penetration of the probe into the dicing tape T was measured, and it was found stable at about 5 μm, with a repetition accuracy of about 1 μm.

As a comparative example, the thickness of the dicing tape T was measured with a non-contact type laser displacement meter (a product of Keyence Corporation, Model No.: LK010) in the same way as in the example of the invention, and the depth of cutting into the works W was controlled on that basis.

Before dicing with the dicing apparatus 10, the thickness of the dicing tape T was measured only with the contact type displacement meter 81 and only with the non-contact type laser displacement meter. It was measured at five points each on the circumference of the dicing tape T around 10 each of works W. Therefore, the total number (n) of positions measured with each displacement meter was 50.

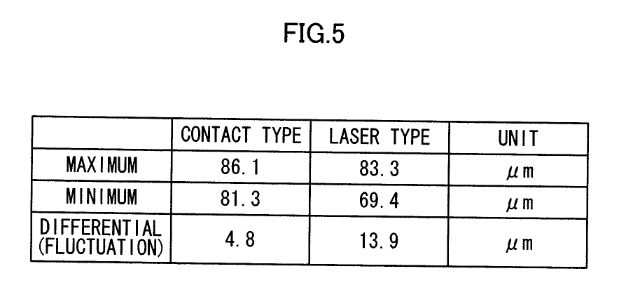

The maximum and minimum measurements and differentials (fluctuations) are tabulated in FIG. 5. This table reveals that the contact type displacement meter 81 was much less in measurement fluctuations than the non-contact type laser displacement meter.

Next, 10 each of works W were machined with the dicing apparatus 10 both in an example of the invention and a comparative example, and the uncut thickness at five points of each work W was measured. Therefore, the total number (n) of measured positions was 50 each.

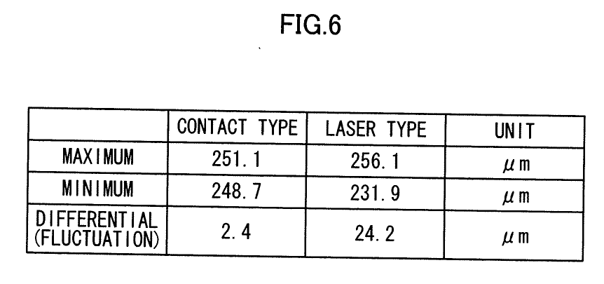

The maximum and minimum measurements and differentials (fluctuations) are tabulated in FIG. 6. This table reveals that the use of the contact type displacement meter 81 in dicing resulted in much less in measurement fluctuations of the uncut thickness than where the non-contact type laser displacement meter was used (about 1/10 in ratio).

Thus, when the non-contact type laser displacement meter is used, water drops remaining on the machining table invite wide fluctuations of the measurements of the dicing tape T, resulting in instability of the uncut thickness left by dicing. However, no such trouble seems to have occurred in these examples of the invention (using the contact type displacement meter 81).

These findings have endorsed the significant effects of these examples.

What is claimed is:

1. A dicing apparatus which machines with rotary blades a groove in, or cuts, a work mounted on a work table, wherein:
a dicing tape to whose upper face the work is stuck can be stuck to or detached from the work table;
a contact type displacement meter for measuring the upper face of the dicing tape fitted to the work table is provided; and
a cutting depth controlling device which controls the depth of cutting by the rotary blades into the work on the basis of the measured position of the upper face of the dicing tape in the vertical direction is further provided.

2. The dicing apparatus according to claim 1, wherein
the contact type displacement meter is supported by the apparatus body via a cylinder device and is enabled to move away from the vicinities of the work table so as not to interfere with the rotary blades.

3. The dicing apparatus according to claim 1, wherein
the minimum length readable by the contact type displacement meter is 1.0 μm or less and the linearity of the measurable range thereof is ±0.5% or less.

4. The dicing apparatus according to claim 1, wherein
the probe pressing force of the contact type displacement meter is less than 2.0 N.

5. The dicing apparatus according to claim 1, wherein
the radius of curvature of the probe tip of the contact type displacement meter is 5 mm or more.

6. The dicing apparatus according to claim 1, further having a mapping device which draws the map of the upper face of the dicing tape from the results of measurement of positions in the vertical direction at a plurality of points on the upper face of the dicing tape detected by the contact type displacement meter, wherein
the cutting depth controlling device controls the cutting depth of the rotary blades on the basis of the map so drawn.

7. The dicing apparatus according to claim 2, wherein
the minimum length readable by the contact type displacement meter is 1.0 μm or less and the linearity of the measurable range thereof is ±0.5% or less.

8. The dicing apparatus according to claim 2, wherein
the probe pressing force of the contact type displacement meter is less than 2.0 N.

9. The dicing apparatus according to claim 2, wherein
the radius of curvature of the probe tip of the contact type displacement meter is 5 mm or more.

10. The dicing apparatus according to claim 2, further having a mapping device which draws the map of the upper face of the dicing tape from the results of measurement of positions in the vertical direction at a plurality of points on the upper face of the dicing tape detected by the contact type displacement meter, wherein
the cutting depth controlling device controls the cutting depth of the rotary blades on the basis of the map so drawn.

11. The dicing apparatus according to claim 3, wherein
the probe pressing force of the contact type displacement meter is less than 2.0 N.

12. The dicing apparatus according to claim 3, wherein
the radius of curvature of the probe tip of the contact type displacement meter is 5 mm or more.

13. The dicing apparatus according to claim 3, further having a mapping device which draws the map of the upper face of the dicing tape from the results of measurement of positions in the vertical direction at a plurality of points on the upper face of the dicing tape detected by the contact type displacement meter, wherein
the cutting depth controlling device controls the cutting depth of the rotary blades on the basis of the map so drawn.

14. The dicing apparatus according to claim 4, wherein
the radius of curvature of the probe tip of the contact type displacement meter is 5 mm or more.

15. The dicing apparatus according to claim 4, further having a mapping device which draws the map of the upper face of the dicing tape from the results of measurement of positions in the vertical direction at a plurality of points on the upper face of the dicing tape detected by the contact type displacement meter, wherein
the cutting depth controlling device controls the cutting depth of the rotary blades on the basis of the map so drawn.

16. The dicing apparatus according to claim 5, further having a mapping device which draws the map of the upper face of the dicing tape from the results of measurement of positions in the vertical direction at a plurality of points on the upper face of the dicing tape detected by the contact type displacement meter, wherein
the cutting depth controlling device controls the cutting depth of the rotary blades on the basis of the map so drawn.

17. A method of dicing to half-cut or semi-fully cut a work by subjecting a work, which is mounted on a work table with a dicing tape in-between and whose lower face is adhesively supported by a dicing tape, to groove cutting or cutting-off with rotary blades, whereby:
the depth of cutting by the rotary blades into the work is controlled on the basis of:
a first measurement by which the upper face of the work table is measured with a contact type displacement meter;
a second measurement by which the upper face of the dicing tape, fitted in the position of the first measurement of the work table, is measured with the contact type displacement meter; and
the result of calculation of the thickness of the dicing tape from the results of the first and second measurements.
